(19) United States
(12) Patent Application Publication
(10) Pub. No.: US 2026/0360892 A1
(43) Pub. Date: Nov. 12, 2026

(54) PLASTIC HOUSING ELEMENT FOR A BATTERY HOUSING AND BATTERY HOUSING

(71) Applicants: POLYTEC Composites NL B.V., Roosendaal (NL); Mercedes-Benz Group AG, Stuttgart (DE)

(72) Inventors: Walter VAN GILST, Roosendaal (NL); Martijn DE KONING, Roosendaal (NL); Martin ZILLER, Stuttgart (DE); Jürgen LENZ, Stuttgart (DE); Evan COLE, Stuttgart (DE)

(21) Appl. No.: 19/649,273

(22) Filed: Apr. 16, 2026

(30) Foreign Application Priority Data
May 9, 2025 (DE) 10 2025 117 842.9

(51) Int. Cl. H01M 50/24; H01M 50/227; H01M 50/262; H01M 50/28

(52) U.S. Cl. CPC H01M 50/24; H01M 50/227; H01M 50/262; H01M 50/28

(57) ABSTRACT

A plastic housing element for a battery housing for accommodating and enclosing a battery cell arrangement, comprising a first and a second cover layer, each formed from a polymer material, and an electromagnetic shielding layer, wherein the first cover layer, the second cover layer and the electromagnetic shielding layer extend substantially congruently along a plane of progression, wherein the electromagnetic shielding layer is at least partially electrically conductive and is arranged between the first cover layer and the second cover layer and is connected to the cover layers in a load-bearing manner to form a housing wall of the plastic housing element, wherein the first cover layer is recessed in an edge region of the housing wall at least in surface portions to expose at least one electrically conductive surface area of the electromagnetic shielding layer as at least one connection surface, and wherein at least one electrically conductive contact element which is elastically deformable transversely to the plane of progression is arranged in the edge region and is electrically conductively contacted or connected to the at least one connection surface.

### CROSS REFERENCE TO RELATED APPLICATIONS

The present application claims priority to German Patent Application 10 2025 117 842.9 filed May 9, 2025, incorporated herein by reference.

According to a first aspect, the present invention relates to a plastic housing element for a battery housing for accommodating and enclosing a battery cell arrangement and, according to a second aspect, to a battery housing.

Housing elements for a battery housing for accommodating and enclosing a battery cell arrangement are already known from the prior art, in particular from the field of automotive engineering. In this respect, it is necessary to electromagnetically shield the battery cells or the battery cell arrangement accommodated in the battery housing from the environment in order to exclude any adverse effects of electromagnetic radiation on the actual battery cell arrangement. It has become known in the prior art that the battery housings, which serve to accommodate and enclose the battery cell arrangement, as well as the housing elements for forming the aforementioned battery housings are made of a thick-walled metal housing, wherein the disadvantage of the prior art is that the aforementioned metal housings and housing elements must be electrically connected to other housing elements by means of expensive insulation measures, for example via screws that rest on the thick-walled metal housing. A particular disadvantage of the aforementioned embodiment is that the thick-walled metal housings are very heavy, still very expensive to manufacture and susceptible to corrosion. Plastic-or fiber-reinforced housings or housing elements have already become known from the prior art, but due to the plastic material used, they generally have insufficient electromagnetic shielding of the battery cell arrangement to be accommodated in the housing, which makes it necessary to provide the aforementioned plastic housings or fiber-reinforced plastic housings with EMC layers, which must first be protected against possible corrosion due to the environmental conditions and, on the other hand, must be provided with complex electrical contact with the other housing elements and the vehicle body, respectively. Thus, the object of the present invention is to provide both a plastic housing element for a battery housing as well as a battery housing comprising an aforementioned plastic housing element for accommodating and enclosing a battery cell arrangement, which eliminates the aforementioned disadvantages, in particular is formed from a genuine material with low weight, while at the same time ensuring the electrical connection of the electromagnetic shielding to other parts. According to a first aspect of the invention, the object is achieved according to the present invention by a plastic housing element for a battery housing for accommodating and enclosing a battery cell arrangement. The plastic housing element according to the invention has a first and a second cover layer, each formed from a polymer material, and an electromagnetic shielding layer. The first cover layer, the second cover layer and the electromagnetic shielding layer extend substantially congruently along a plane of progression, wherein the electromagnetic shielding layer is at least partially electrically conductive and is arranged between the first cover layer and the second cover layer and is connected to the cover layers in a load-bearing manner to form a housing wall of the plastic housing element; wherein the first cover layer is recessed at least in surface portions to expose at least one electrically conductive surface area of the electromagnetic shielding layer as at least one connection surface; and wherein at least one electrically conductive contact element which is elastically deformable transversely to the plane of progression is arranged in the edge region and is electrically conductively contacted or connected to the at least one connection surface. The electrically conductive contact element therefore protrudes from the plane of progression.

The first cover layer is preferably recessed in an edge region, at least in surface portions along a circumference.

According to the invention, it may be provided that the at least one electrically conductive contact element is formed in the edge region at least circumferentially in large parts of a circumference, particularly preferably circumferentially along the entire circumference.

Preferably, it may be provided according to the invention that reinforcing ribs are formed in the region of the first and/or the second cover layer, which project transversely to the plane of extension from the first and/or second cover layer. Particularly preferably, the reinforcing ribs can be formed in the edge region of the housing wall. In this respect, the reinforcing ribs can form a honeycomb structure or a box structure along the plane of extension. The reinforcing ribs can be formed on the inside of the battery box, wherein the reinforcing ribs can be formed particularly preferably on the inside of the battery box to form additional functions, such as for fluid and/or particle guidance in the event of a thermal runaway in the battery cell arrangement. The ribs can also be used to increase the bending stiffness and crash stability of the housing wall.

It may be provided that the plastic element according to the invention further optionally comprises a core layer, wherein the core layer is arranged between the electromagnetic shielding layer and the second cover layer and extends substantially along the plane of progression and is connected to the electromagnetic shielding layer and the second cover layer in a load-bearing manner.

It may be provided that the contact element is elastically resilient at least transversely to the plane of progression, in particular projects elastically resiliently from the plane of transversely or orthogonally to the plane of progression.

It may be provided that the contact element is made of a metallized plastic foam or comprises a metallized plastic foam.

A metallized plastic foam is basically a foamed plastic base material which is coated with a metallic layer, more precisely a metallic electrically conductive layer, at least on the surfaces.

According to the invention, the term metallized plastic foam is to be understood to mean, for example, a foamed elastic polymer material which is at least partially surrounded by an electrically conductive material.

Preferably, the electrically conductive sheath is formed from a foil, a textile or a coating, largely consisting of an electrically conductive metallic material, such as aluminum, copper or steel in particular. Alternatively, according to the invention, a foamed elastic polymer material filled with electrically conductive particles can also be provided as the metallized plastic foam.

According to the invention, the plastic foam can form at least part of preferably the edge region of the electromagnetic shielding layer in an elastically resilient manner.

According to the invention, it may be provided that the first and/or the second cover layer is/are formed from a fiber-reinforced polymer material, preferably from a polymer material with continuous fiber reinforcement.

It may be provided that the fiber-reinforced polymer material comprises several individual layers, preferably comprising at least one individual layer of a fiber-reinforced polymer material, particularly preferably comprising at least one unidirectionally reinforced fiber composite layer.

The reinforcing fibers can be arranged along a plane of progression, preferably the longitudinal fiber axes can be aligned in the main load directions, particularly preferably the fiber-reinforced polymer material is made of a thermoplastic material.

It may also be provided that the core layer is formed from a polymer material, preferably from a polymer material with long fiber reinforcement or short fiber reinforcement, particularly preferably from a polymer material with glass or carbon fiber reinforcement.

It may be provided that the core layer is formed of a foamed polymer material.

The core layer can be produced as a long-fiber-reinforced thermoplastic using a direct process.

A direct process is, in particular, an injection molding or impact extrusion process.

The electromagnetic shielding layer can comprise a plastic carrier layer and a conductive layer, wherein the conductive layer is oriented towards the contact element and comprises an electrically conductive fabric, an electrically conductive foil or an electrically conductive coating, wherein the fabric, foil or coating preferably contains aluminum, copper or steel.

It may be provided that an inner sealing bead and/or an outer sealing bead is arranged in the edge region parallel to the contact element.

The contact element can protrude beyond the inner and/or outer sealing bead in a direction transverse to the plane of progression.

It may be provided that a plurality of passage openings is arranged in the edge region, wherein each passage opening is configured for fastening the plastic housing element to an opposing housing structure or to a structural component by means of a fastening element.

The plastic housing element can be configured as a housing cover for a battery housing.

Alternatively, it may be provided that the plastic housing element is alternatively configured as a housing tray for a battery housing.

According to a second aspect, the present invention relates to a battery housing with at least a first plastic housing element according to the embodiments of the first aspect of the present invention, wherein the battery housing comprises a second plastic housing element which comprises a further electromagnetic shielding layer, wherein the contact element of the first plastic housing element is electrically conductively contacted or connected to the further electromagnetic shielding layer of the second plastic housing element.

In the following, with reference to the accompanying figures, exemplary embodiments of plastic housing elements according to the invention for a battery housing for accommodating and enclosing a battery as well as an exemplary embodiment of a battery housing according to the invention are shown.

### IN THE FIGURES

FIG. 1A shows a schematic sectional view of a first exemplary embodiment of a plastic housing element according to the invention;

FIG. 1B shows an enlarged edge section of the plastic housing element according to the invention as shown in FIG. 1A;

FIG. 2A shows a schematic sectional view of a second exemplary embodiment of a plastic housing element according to the invention;

FIG. 2B shows the enlarged edge section of the exemplary embodiment according to FIG. 2A;

FIG. 3A shows a further schematic sectional view of a third exemplary embodiment of the plastic housing element according to the invention;

FIG. 3B again shows the enlarged sectional view of the edge region according to FIG. 3A;

FIG. 4 shows the enlarged view of an edge section of a further exemplary embodiment of a plastic housing element; and

FIG. 5 shows a schematic sectional view 1 of an exemplary battery housing in a disassembled state.

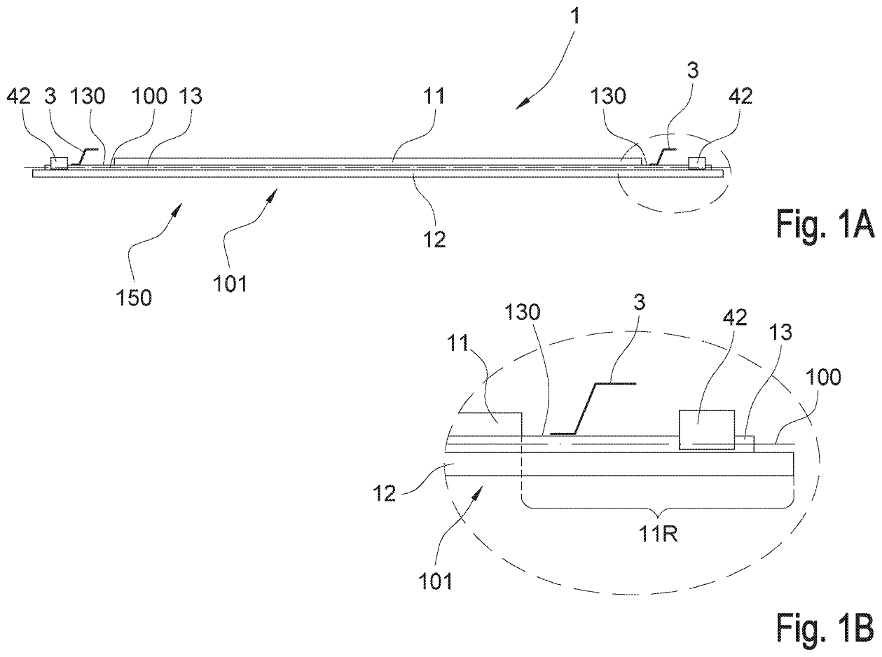

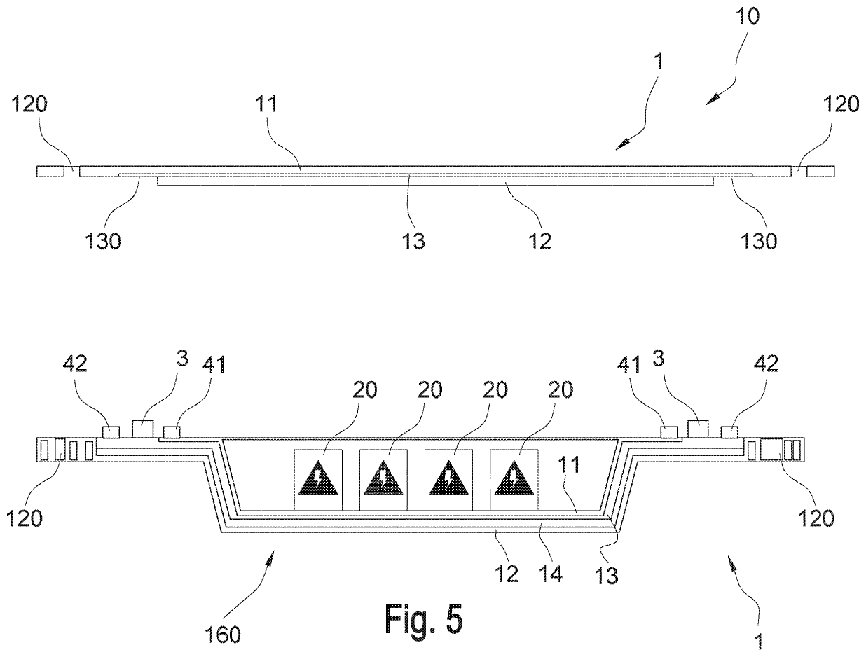

FIG. 1A shows a first exemplary embodiment of a plastic housing element 1 according to the invention in a schematic sectional view. The plastic housing element 1 according to the invention serves to form a battery housing 10 for accommodating and enclosing a battery cell arrangement 20, as shown by way of example in FIG. 5. The plastic housing element 1 shown in FIG. 1A forms a housing portion or, more precisely, a wall portion of the battery housing 10.

The plastic housing element 1 according to the invention has a first cover layer 11 and a second cover layer 12, which are each formed from a polymer material, and also has an electromagnetic shielding layer 13.

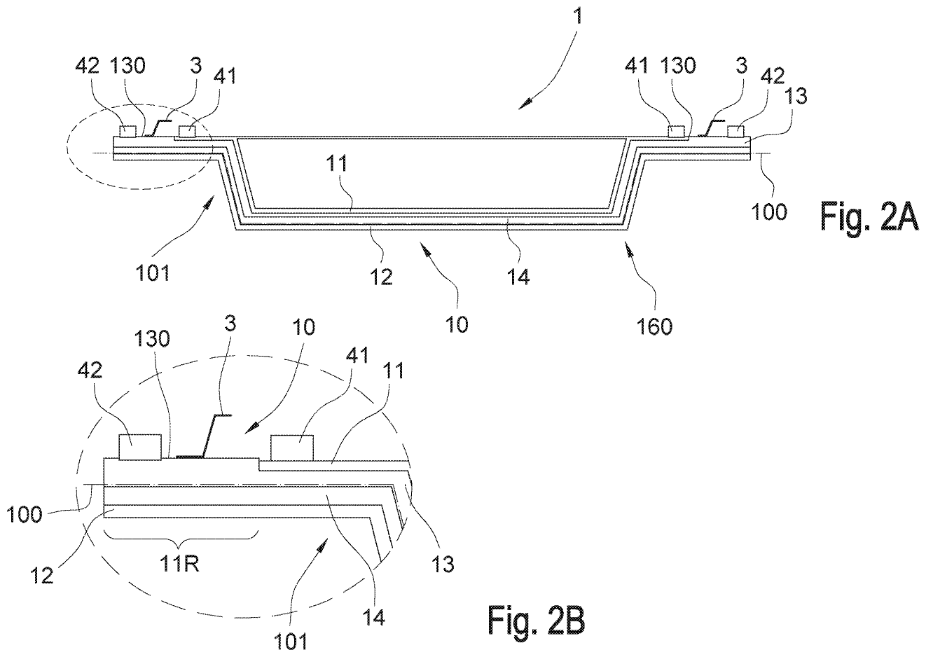

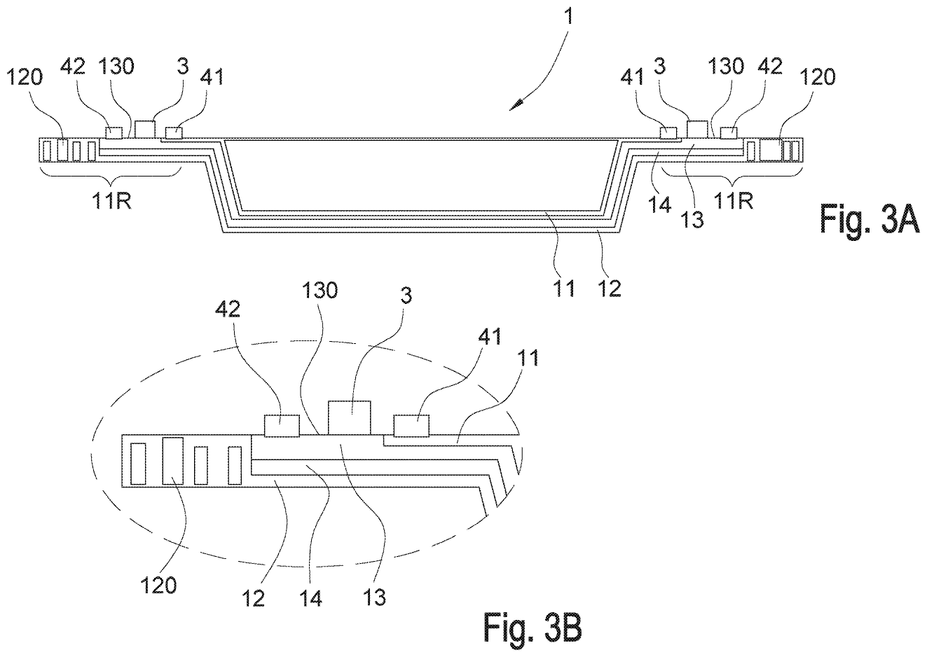

The first cover layer 11, the second cover layer 12 and the electromagnetic shielding layer 13 extend substantially congruently along a plane of progression 100, which is shown in the figures by a dot and dash line. In FIG. 1A, the plane of progression 100 extends along a flat plane. According to the invention, however, it may also be provided, as shown by way of example in FIGS. 2A and 3A, that the plane of progression 100 also partially has curvatures or protrusions, so that the plastic housing element according to the invention can also be formed in the shape of a tray in deviation from the embodiment according to FIG. 1A, in which the plastic housing element 1 is substantially formed as a plate-shaped element along a flat plane of progression 100.

The electromagnetic shielding layer 13 is configured to be at least partially electrically conductive and is arranged between the first cover layer 11 and the second cover layer 12 and is connected to the two aforementioned cover layers 11, 12 in a load-bearing manner to form a housing wall 101 of the plastic housing element 1. In this respect, the cover layer 11 is recessed in an edge region 11R at least in parts of the surface areas to expose at least one electrically conductive surface area 130 of the electromagnetic shielding layer 13 as at least one connection surface. In this respect, at least one electrically conductive contact element 3 which is elastically deformable transversely to the plane of progression 10 is arranged in the edge region 11R and is electrically conductively contacted with and/or connected to the at least one connection surface. In the embodiment shown in FIG. 1A, the electrically conductive contact element 3 is configured as an elastically resilient projecting strip of material that protrudes from the contact surface and extends in a Z-shape.

In the embodiment according to FIG. 1A, an outer sealing bead 42 is arranged circumferentially and parallel to the contact element 3.

FIG. 1B shows the exemplary structure of the plastic housing element according to FIG. 1A in detail.

According to the invention, it may be provided that the first cover layer 11 and/or the second cover layer 12 is formed from a fiber-reinforced polymer material, preferably from a polymer material with a continuous fiber reinforcement.

In this respect, the fiber-reinforced polymer material can comprise, according to the invention, several individual layers, preferably comprising at least one individual layer of a fiber-reinforced polymer material, particularly preferably comprising at least one unidirectionally reinforced fiber composite layer.

According to the invention, the electromagnetic shielding layer can comprise a plastic carrier layer and a conductive layer and an electrically conductive conductor layer, wherein the conductive layer is oriented towards the contact element 3 and comprises an electrically conductive fabric, an electrically conductive foil or an electrically conductive coating, wherein the fabric, foil or coating preferably contains aluminum, copper or steel.

As shown in FIG. 1A, the plastic housing element 1 can be configured as a housing cover 150 for a battery housing 10 (see FIG. 5).

FIG. 2A shows a further exemplary embodiment of a plastic housing element 1 according to the invention, which differs from the embodiment according to FIGS. 1A and 1B in that the exemplary plastic housing element 1 is configured as a housing tray 160 for a battery housing 10 (see FIG. 5).

Furthermore, the embodiment according to FIG. 2A differs from FIG. 1A in that the plastic housing element 1 further comprises a core layer 14, wherein the core layer 14 is arranged between the electromagnetic shielding layer 13 and the second cover layer 12 and extends substantially along the plane of progression 100 and is connected to the electromagnetic shielding layer 13 and the second cover layer 12 in a load-bearing manner.

As indicated by the dot and dash line in FIGS. 2A and 2B, the plane of progression 100 does not extend in a flat plane, as in FIGS. 1A and 1B, but rather has a recessed space in the middle and is thus partially curved.

Furthermore, in contrast to the embodiment shown in FIG. 2A, the plastic housing element 1 now has both an inner sealing bead 41 and an outer sealing bead 42 circumferentially in the edge region 11R parallel to the contact element 3. As shown, the contact element 3 can protrude beyond the inner and/or outer sealing bead 41, 42 in a direction transverse to the plane of progression 100.

FIG. 2B again shows the exact arrangement and configuration of the exemplary plastic housing element 1 according to FIG. 2A in the edge region 11R.

FIG. 3A shows a schematic sectional view of a third exemplary embodiment of a plastic housing element 1 according to the invention, which differs from the exemplary embodiment according to FIGS. 2A and 2B in that the contact element 3 is no longer Z-shaped, but rather, in the embodiment shown according to FIGS. 3A and 3B, is formed from a metallized plastic foam which protrudes elastically relative to the plane of progression 100. The embodiment according to FIGS. 3A and 3B further differs from FIGS. 2A and 2B in that a plurality of passage openings 120 are arranged or formed in the edge region 11R, wherein each passage opening 120 is formed for fastening the plastic housing element 1 to an opposing housing structure or to a structural component by means of a fastening element.

In FIG. 3A, the plastic housing element 1 is again configured in the type and shape of a housing tray 160 for a battery housing 10.

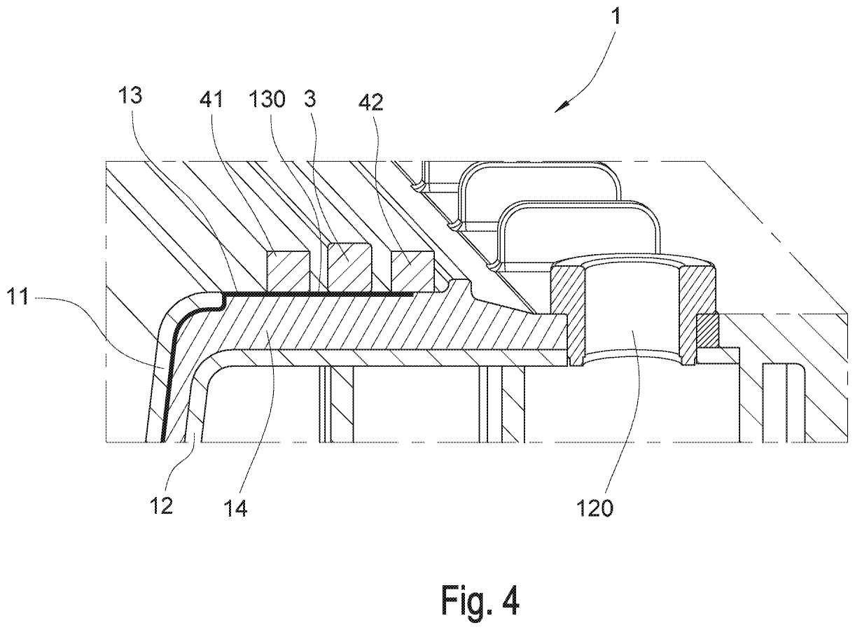

FIG. 4 shows a further exemplary embodiment of a plastic housing element 1 according to the invention in a schematic sectional view and in a perspective view for improved illustration of the embodiment according to FIGS. 3A and 3B. In contrast to the embodiment shown in FIGS. 3A and 3B, the embodiment shown in FIG. 4A also has ribs in the edge region, which are formed over the core layer to increase the stiffness in the edge region.

FIG. 5 shows the exemplary embodiment of a battery housing 10 comprising a first plastic housing element 1, which is configured as a housing cover 150 according to the embodiment of FIGS. 1A and 1B. The illustrated second plastic housing element 1 is configured in the form of a housing tray 160 for the battery housing 10 in the manner of the exemplary embodiment shown in FIGS. 3A and 3B. FIG. 5 also shows how, by way of example, the battery cells 20 can be accommodated in the battery housing 10 and can be enclosed and sealed on all sides when the battery housing cover 150 shown is joined to the housing tray 160. For simplified illustration, the housing cover 150 is shown at a distance from the housing tray 160 in FIG. 5 in order to better illustrate the connection areas in particular. The housing cover 150 can be sealed or joined to the housing tray 160 in a fluid-tight manner via the designed plurality of passage openings 120.

What is claimed is:

1. A plastic housing element (1) for a battery housing (10) for accommodating and enclosing a battery cell arrangement (20), comprising:
a first and a second cover layer (11, 12), each formed from a polymer material, and
an electromagnetic shielding layer (13);
wherein the first cover layer (11), the second cover layer (12) and the electromagnetic shielding layer (13) extend congruently along a plane of progression (100),
wherein the electromagnetic shielding layer (13) is configured to be at least partially electrically conductive and is arranged between the first cover layer (11) and the second cover layer (12) and is connected to the cover layers (11, 12) in a load-bearing manner to form a housing wall (101) of the plastic housing element (1);
wherein the first cover layer (11) is recessed in an edge region (11R) of the housing wall (101) at least in surface portions to expose at least one electrically conductive surface area (130) of the electromagnetic shielding layer (13) as at least one connection surface; and
wherein at least one electrically conductive contact element (3) which is elastically deformable transversely to the plane of progression (100) is arranged in the edge region (11R) and is electrically conductively contacted or connected to the at least one connection surface.

2. The plastic housing element (1) according to claim 1, further comprising a core layer (14), wherein the core layer (14) is arranged between the electromagnetic shielding layer (13) and the second cover layer (12) and extends along the plane of progression (100) and is connected to the electromagnetic shielding layer (13) and the second cover layer (12) in a load-bearing manner.

3. The plastic housing element (1) according to claim 1, wherein the contact element (3) is configured to be elastically resilient at least transversely to the plane of progression (100).

4. The plastic housing element (1) according to claim 3, wherein the contact element (3) comprises a metallized plastic foam.

5. The plastic housing element (1) according to claim 1, wherein the first (11) and/or the second (12) cover layer is/are formed from a fiber-reinforced polymer material.

6. The plastic housing element according to claim 5, wherein the fiber-reinforced polymer material comprises continuous fiber reinforcement.

7. The plastic housing element (1) according to claim 5, wherein the fiber-reinforced polymer material comprises several individual layers, comprising at least one individual layer of a fiber-reinforced polymer material.

8. The plastic housing element (1) according to claim 5 comprising at least one unidirectionally reinforced fiber composite layer.

9. The plastic housing element (1) according to claim 2, wherein the core layer (14) is formed from a polymer material with long fiber reinforcement or short fiber reinforcement.

10. The plastic housing element according to claim 9, wherein the polymer material comprises glass or carbon fiber reinforcement.

11. The plastic housing element (1) according to claim 2, wherein the core layer (14) is formed from a foamed polymer material.

12. The plastic housing element (1) according to claim 2, wherein the core layer (14) is produced as a long-fiber-reinforced thermoplastic by a direct process.

13. The plastic housing element (1) according to claim 1, wherein the electromagnetic shielding layer (13) comprises a plastic carrier layer and a conductive layer, wherein the conductive layer is oriented towards the contact element (3) and comprises an electrically conductive fabric, an electrically conductive foil or an electrically conductive coating.

14. The plastic housing element according to claim 13, wherein the fabric, foil or coating comprises aluminum, copper or steel.

15. The plastic housing element (1) according to claim 1, wherein an inner sealing bead (41) and an outer sealing bead (42) is arranged circumferentially parallel to the contact element (3) in the edge region (11R), wherein the contact element (3) is arranged between the inner and outer sealing bead (41, 42) along the plane of progression (100).

16. The plastic housing element (1) according to claim 15, wherein the contact element (3) protrudes beyond the inner (41) and/or outer (42) sealing bead in a direction transverse to the plane of progression (100).

17. The plastic housing element (1) according to claim 1, wherein a plurality of passage openings (120) is arranged in the edge region (11R), wherein each passage opening (120) is configured for fastening the plastic housing element (1) to an opposing housing structure or to a structural component by means of a fastening element.

18. The plastic housing element (1) according to claim 1, wherein the plastic housing element (1) is designed as a housing cover (150) for a battery housing (10).

19. The plastic housing element (1) according to claim 1, wherein the plastic housing element (1) is designed as a housing tray (160) for a battery housing (10).

20. A battery housing (10) with a first plastic housing element (1) according to claim 1, wherein the battery housing (10) comprises a second plastic housing element (1) which has a further electromagnetic shielding layer (13), wherein the contact element (3) of the first plastic housing element (1) is electrically conductively contacted or connected to the further electromagnetic shielding layer (13) of the second plastic housing element (1).
